(19) United States
(12) Patent Application Publication
(10) Pub. No.: US 2003/0100312 A1
(43) Pub. Date: May 29, 2003

(54) Radio communication apparatus

(76) Inventor: Satoshi Takahashi, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/076,567

(22) Filed: Feb. 19, 2002

(30) Foreign Application Priority Data
Nov. 29, 2001 (JP) 2001-363560

(51) Int. Cl. H04Q 7/20

(52) U.S. Cl. 455/453; 455/522; 455/63

(57) ABSTRACT

In the radio communication apparatus of the present invention, a communication state of a terminal is reported from the terminal. According to the communication reported from the terminal, a base station decides power of a signal transmitted to the terminal. The base station has a terminal identification equipment for identifying information inherent to the terminal. The base station has a priority control equipment. The priority control equipment receives a service type requested by a user of the terminal. According to the information inherent to the terminal identified by the terminal identification equipment, the priority control equipment receives a service type. The base station has signal transmission means. This signal transmission means transmits a signal to the terminal. The signal transmission means transmits the signal to the terminal with power according to the service type received by the priority control equipment.

### CROSS-REFERENCE TO RELATED APPLICATIONS

The present invention is based on Japanese Patent Application 2001-363560 filed Nov. 29, 2001 to Japan, the contents of which are incorporated herein by reference.

### FIELD OF THE INVENTION

The present invention relates to a radio communication system using a spectrum diffusion communication method, and more particularly, it relates to a technique for changing a transmission rate or electric power for communication between a base station and a terminal.

### BACKGROUND OF THE INVENTION

As a communication method in which channel discrimination by a code type is used and a plurality of base stations share an identical frequency band, there is a code division multiple access (CDMA).

As a mobile telephone method employing this CDMA, Qualcomm Co., Ltd. of the USA has developed IS-95 (cdmaOne). In the IS-95, to effectively utilize a radio frequency, a packet communication technique is used. The packet communication technique referred to herein is a technique release a telephone line excluding the time when data transmission is performed. In the IS-95, the transmission rate is always constant and fixed. In the IS-95, since a distance of from a base station to a terminal varies depending on the location of the terminal, a radio wave transmitted/received between the base station and a terminal located far from the base station is interfered by a radio wave transmitted/received between the base station and a terminal located near to the base station. Accordingly, in the IS-95, in order to reduce the radio wave interference, power control is used. Explanation will be given on the power control of the IS-95. In case of a down signal from a base station to a terminal, transmission is controlled in such a manner that the signal is transmitted with a weak power to a terminal near to the base station and with a strong power to a terminal far from the base stations. Similarly, in case of an up signal from a terminal to the base stations, control is performed in such a manner that transmission is performed with a weak power from a terminal near to the station and with a strong power from a terminal far from the base station. In the power control of the IS-95, in case of a down signal from a base station to a terminal, the base station adjusts the transmission power. The transmission power adjustment for transmission from a base station is disclosed in Japanese Patent Application 2001-36463. Thus, according to the IS-95, transmission power of a down signal from a base station to a terminal is controlled, so as to obtain a uniform communication quality between terminals. Furthermore, in the power control of the IS-95, the base station controls the transmission power to all the terminals to be as small as possible. The reason why the transmission power is set as small as possible is that by reducing the transmission power of the base station, it is possible to reduce radio wave interference with other base stations. By reducing the radio wave interference with the other base stations, an entire system including a plurality of base stations can contain a significantly large number of terminals.

On the other hand, there is a mobile telephone connection method HDR (high data rate) which has been developed to use the packet communication technique but is intended mainly for data communication. The HDR has an advantage that hardware can be simplified and power consumption can be suppressed. A system using the HDR is described in IEE Communication Magazine, pp. 70-77, July 2000. Unlike the IS-95, the HDR can change the transmission rate both for a down signal from a base station to a terminal and an up signal from a terminal to a base station. Explanation will now be given on a transmission rate change for the down signal from a base station to a terminal. In the HDR, a terminal measures a communication state between the terminal and the base station and reports the measurement result to the base station. According to the communication state reported, the base station changes the modulation method and the processing gain. Here, the processing gain is a gain obtained by performing spectrum diffusion. The base station allocates data in a packet slot time-divided by employing the time division multiple access (TDMA) when transmitting data to a terminal. In the HDR, by employing the TDMA, a terminal can occupy the entire band instantaneously, effectively assuring the information communication capacity. In the HDR, a base station changes the modulation method and the processing gain according to the communication state between the base station and a terminal. Thus, when the communication state is preferable, it is possible to communicate at a high rate. When a high-rate communication is performed, the communication can be completed in a short time, which in turn can make a lot of packets empty. Accordingly, the base station can communicate with a greater number of terminals. On the other hand, in the HDR, when the communication state is not preferable, the base station performs communication at a low rate, thus assuring a stable communication. Thus, in the HDR, it is possible to change the transmission rate of the down signal from a base station to a terminal and accordingly, one base station can transmit a greater data quantity to respective terminals.

The modulation method and the processing gain can be determined by the carrier-to-interference power ratio (C/I). In the HDR, a terminal measures intensity of pilot signals of the base station and divides the maximum intensity among the pilot signals by a sum of the other intensities, thereby obtaining a C/I. The base station decides the modulation method and the processing gain according to the C/I transmitted from the terminal. The base station decides that a terminal having a greater C/I is in a better communication state and selects multi-value modulation or selects a lower processing gain.

In the HDR, a terminal can change the transmission rate of an up signal from the terminal to a base station. In this case, the terminal decides the signal transmission rate according to the C/I. The terminal uses the decided transmission rate to transmit the up signal to the base station.

Similarly as in the IS-95, the HDR also employs power control. However, the power control of the HDR is different from the IS-95 in case of a down signal from a base station to a terminal. In the power control of the HDR, in case of a down signal from a base station to a terminal, the transmission power from the base station to the terminal is always constant and is fixed. FIG. 1 shows a change of power transmitted from the base station along time. In FIG. 1, the vertical axis represents a down signal transmission power from the base station to terminals. The horizontal axis represents time. FIG. 1 shows that the transmission power 1100 is constant for all the terminals. In FIG. 1, three terminals (terminal 1 to 3) are controlled under one base station. The base station transmits data to the three terminals by using packet slots time-divided by the TDMA. The three terminals receive a signal by using an identical transmission power 1100. The transmission power 1100 is a value smaller than a maximum transmission power for transmission from the base station to the terminals. The reason why communication is performed at a power smaller than the maximum transmission power is that by reducing the transmission power of the base station as small as possible, it is possible to reduce radio wave interference to the other base stations. By reducing radio wave interference to the other base stations, the entire system including a plurality of base stations can contain a greater number of terminals.

On the other hand, in case of an up signal from a terminal to a base station, the power control is identical to that of the IS-95. Power is controlled in such a manner that transmission is performed with a weak power when the terminal is located near to the base station and with a strong power when the terminal is located far from the base station.

In the IS-95, a base station controls transmission power of a down signal to a terminal from the base station according to the C/I reported from the terminal, thereby obtaining a uniform communication quality between terminals.

However, in the HDR, the communication quality is not constant and varies depending on the radio wave condition. That is, in the HDR, transmission power of a down signal from a base station to a terminal is always constant and fixed and accordingly, transmission power is identical when a signal is transmitted to a terminal located near to the base station and when a signal is transmitted to a terminal located far from the base station. Consequently, the communication quality is relatively worse in the terminal far from the base station as compared to the terminal near to the base station.

Thus, the HDR cannot assure a communication quality required for terminals. That is, the communication quality becomes worse as the distance from the base station increases and accordingly, it is impossible to provide a preferable communication quality required at the terminal.

Furthermore, in the power control of the IS-95, a base station adjusts a down signal transmission power according to a C/I reported from a terminal. For this, transmission power of the down signal from the base station to the terminal is repeatedly increased, which deteriorates the communication quality. This is described in the column of the problems to be solved by the invention disclosed in Japanese Patent Publication 2001-36463. In the Japanese Patent Publication 2001-36463, in order to eliminate such a situation, a total of the transmission power of all the down signals from the base station to the terminals is observed and the transmission power is relatively increased for a terminal having a higher priority than a terminal having a lower priority. However, the invention disclosed in this Publication employs the CDMA for a down signal from a base station to terminals. In this case, the base station simultaneously transmits to a plurality of terminals. For this, even if the invention disclosed in this Publication can solve the problem described in the column of the problems to be solved, the processing load for the base station is increased. That is, the base station should have the load of observing the total of the transmission power of all the down signals transmitted to the terminals.

On the other hand, in the HDR, the transmission rate can be changed and accordingly, a greater data quantity can be transmitted from a base station to a terminal. That is, in the HDR, communication can be performed with a higher rate to a terminal having a preferable communication state or communication can be performed with a higher rate for a terminal for which transmission rate from the base station need not be high. Accordingly, a communication from the base station to the terminal can be completed in a short time, thereby effectively utilizing communication resources.

However, in the IS-95, the communication rate is always constant and fixed. Accordingly, in the IS 95, the base station cannot transmit a greater data quantity to a terminal.

### SUMMARY OF THE INVENTION

It is therefore an object of the present invention to provide a communication system capable of solving the problems of the IS-95 and the HDR. That is, an object of the present invention is to provide a communication system capable of assuring a communication quality according to the communication quality requested at a terminal.

Moreover, another object of the present invention is to provide a communication system capable of achieving the technique for a terminal to indicate transmission power increase/decrease of a down signal, to a base station.

Moreover, still another object of the present invention is to provide a communication system capable of effectively utilizing communication resources.

In order to achieve the aforementioned objects, the present invention has configuration as follows.

The radio communication apparatus of the present invention, for example, operates as follows. A base station receives a report of a communication state of a terminal from the terminal. The communication state of the terminal is grasped, for example, by using carrier-to-interference power ratio C/I. The base station decides power intensity of a signal transmitted to the terminal according to the carrier-to-interference power ratio C/I reported from the terminal. The base station has identification means for identifying a device number of the terminal, for example. This identification means is, for example, a terminal identification equipment. The base station has condition fetch means such as a priority control equipment. The priority control equipment receives a condition requested by a user of the terminal such as a service type. The priority control equipment receives from a control station the condition requested by the user of the terminal according to the device number of the terminal identified by the terminal identification equipment. The base station includes signal transmission means such as a transmission power decision equipment, a transmission power control equipment, a power amplifier, an antenna-sharing equipment or an antenna. This signal transmission means transmits a signal to the terminal. The signal transmission means transmits the signal to the terminal with power intensity according to the condition received by the priority control equipment. The base station has signal transmission rate change means such as a transmission rate decision equipment. This transmission rate decision equipment changes the transmission rate of the signal transmitted to the terminal according to the carrier-to-interference power ratio C/I reported from the terminal.

The base station receives a signal such as data transmitted from the terminal. The base station checks the content of the signal received. If the signal is related to a terminal location such as a location update request, the base station reports the terminal location to an upper-node station. The upper-node station is, for example, a control station. If the signal is related to connection from the terminal such as a line connection request, the base station asks the control station about the service type. The base station decides transmission power of the signal transmitted to the terminal according to the service type. If the signal is service type change request, the base station requests the control station to update the service type.

The communication apparatus of the present invention such as the control station is connected to a lower-node station located at the side of the terminal. The lower-node station is, for example, a base station. The control station has an inter-lower-node connection block such as inter-base-station interface. The inter-base-station interface receives a signal transmitted from a base station and transmits the signal to a base station. The base station is connected to a storage equipment such as a database. The base station has an inter-storage-equipment connection block such as an inter-database interface. The inter-database interface transmits the signal to a database. The base station has an inter-data-network connection block such as an inter-data-network interface. The inter-data-network interface is connected to a data network and transmits/receives a signal to/from the data network. The base station has a control block such as a control equipment. The control equipment is connected to the inter-base-station interface, inter-database interface, or inter-data-network interface. The control equipment identifies a content of a signal received via the inter-base-station interface. If the signal is a location update request, the control equipment performs control so as to report the location update request to the database. If the signal is related to a condition requested by a user of the terminal such as a service type query, the control equipment performs control so as to ask the database about the service type. The control equipment performs control so that the signal transmitted from the base station is transmitted via the inter-network interface to the data network. The control equipment performs control, so that the signal received via the inter-data-network interface from the data network is transmitted via the inter-base-station interface to the base station. If the signal is a service type change request, the control equipment performs control, so as to request the database to update the service type via the inter-base interface.

The storage device of the present invention such as a database is connected to the control station. The database has a connection equipment for connecting the communication apparatuses such as an inter-control-station interface. This inter-control-station interface receives a signal transmitted from a control station or transmits a signal to the control station. The database equipment stores information about the terminal location, information about the data quantity of data transmitted and received to/from a terminal, or a service type. The information about the terminal location is, for example, a location area. The information about the data quantity of data transmitted and received to/from the terminal is, for example, a transmission data quantity or a reception data quantity. The database has a control equipment such as a database control equipment. The database control equipment is connected to the inter-control-station interface or a data base equipment. The database control equipment identifies a content of a signal received via the inter-control-station interface. If the signal is a location update request, then the database control equipment performs control, so that the location area stored in the database equipment is updated. If the signal is related to the data quantity of data transmitted and received by the terminal, then the database performs control so as to update the transmission data quantity or the reception data quantity stored in the database. The information about the data quantity of data transmitted/received by the terminal is, for example, a request for updating a transmission data quantity or a reception data quantity. If the signal is related to a condition requested by a user of the terminal, then the database control equipment performs control so as to retrieve a service type stored in the database equipment. The condition requested by the user of the terminal is, for example, a service type query. When the signal is a request for changing the service type, the database equipment performs control, so as to update the service type stored in the database equipment to a service type requested by the user of the terminal. The database equipment calculates a fee to be paid by the user of the terminal according to the service type updated by the user of the terminal. The database control equipment performs control, so as to update information about the fee to be paid by the user of the terminal. The information about the fee to be paid by the user of the terminal is, for example, an additional fee stored in the database equipment.

The terminal of the present invention may be applied, for example, to a High Data Rate mobile telephone. The terminal has report means. The report means reports a carrier-to-interference power ratio C/I to the communication apparatus such as a base station. The terminal has reception means. The reception means receives a signal transmitted from the base station. A signal transmitted from the base station has a power value decided by the base station according to the carrier-to-interference power ratio C/I reported from the terminal. The terminal has display means such as a display screen. The display screen displays a first condition related to the power requested by a user of the terminal in advance, for example, a service type. When the service type requested in advance by the user of the terminal is updated, the display screen displays the service type updated. Thus, by displaying the service type updated, the user of the terminal can confirm the service type updated. After the user of the terminal has confirmed the updated service type, the terminal requests the base station to update the service type. The terminal has request acceptance means such as a button. The button accepts update of the service type from the user of the terminal. The terminal has control means. The control means identifies a content of the request performed via the button by the user of the terminal. If the request from the user of the terminal is a line interface request, then the control means performs control via the report means, so that the base station is requested to connect a line. If the request from the user of the terminal is a service type update, then the control means performs control via the report means, so that the base station is requested to update the service type requested in advance. The report means requests the base station to update the service type as has been requested by the user of the terminal. The report means requests the base station to update the service type as has been requested by the user of the terminal.

According to the present invention as a whole, it is possible to provide a communication system capable of solving the problems of the IS-95 and the HDR. That is, it is possible to provide a communication system capable of assuring a communication quality according a communication quality requested by a terminal.

Moreover, it is possible to provide a communication system capable of solving the problem of the technique that the terminal indicates to the base station, increase/decrease of a transmission power of a down signal.

Moreover, it is possible to provide a communication system capable of transmitting more data from the base station to the terminal.

Furthermore, it is possible to provide a communication system capable of effectively utilizing communication resources.

### BRIEF DESCRIPTION OF THE DRAWINGS

Preferred embodiments of the present invention will now be described in conjunction with the accompanying drawings, in which:

FIG. 1 shows a change of electric power transmitted from a base station, along time.

FIG. 2 shows an entire configuration of a communication system according to the invention.

FIG. 3 shows information items held in a database 60 according to the present invention.

FIG. 4 is a block diagram of a base station 20 according to the present invention.

FIG. 5 shows information items stored in a priority control equipment 311 of the base station 20 according to the present invention.

FIG. 6 shows a communication sequence of the present invention.

FIG. 7 is a flowchart of the base station 20 of the present invention.

FIG. 8 is a block diagram of a control station 30 of the present invention.

FIG. 9 is a flowchart of a control equipment 700 of the control station 30 of the present invention.

FIG. 10 is a block diagram of the database 60 of the present invention.

FIG. 11 is a flowchart of a database control equipment 900 of the database 60 of the present invention.

FIG. 12 shows a change of electric power transmitted from the base station 20 along time according to the present invention.

FIG. 13 shows a transmission rate change of the base station 20 along time according to the present invention.

FIG. 14 shows a communication sequence of the present invention.

FIGS. 15A-15D show display screens of a terminal 10 when a service type is changed.

FIG. 16 is a flowchart of the terminal 10 of the present invention.

FIG. 17 is a flowchart of the base station 20 of the present invention.

FIG. 18 is a flowchart of the control equipment 700 of the control station 30 of the present invention.

FIG. 19 is a flowchart of the database control equipment 900 of the database 60 of the present invention.

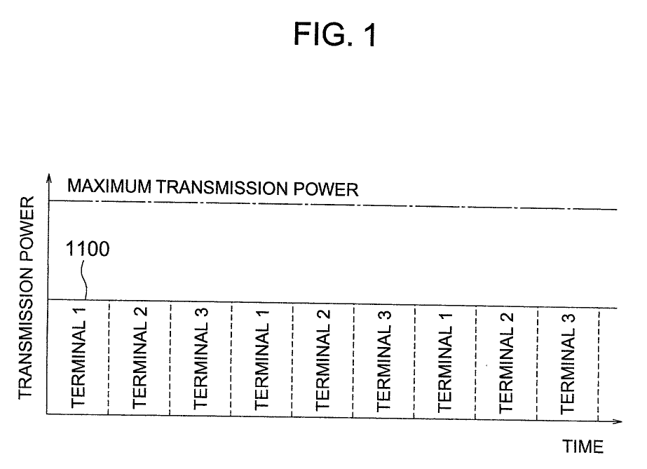

### DESCRIPTION OF THE EMBODIMENTS

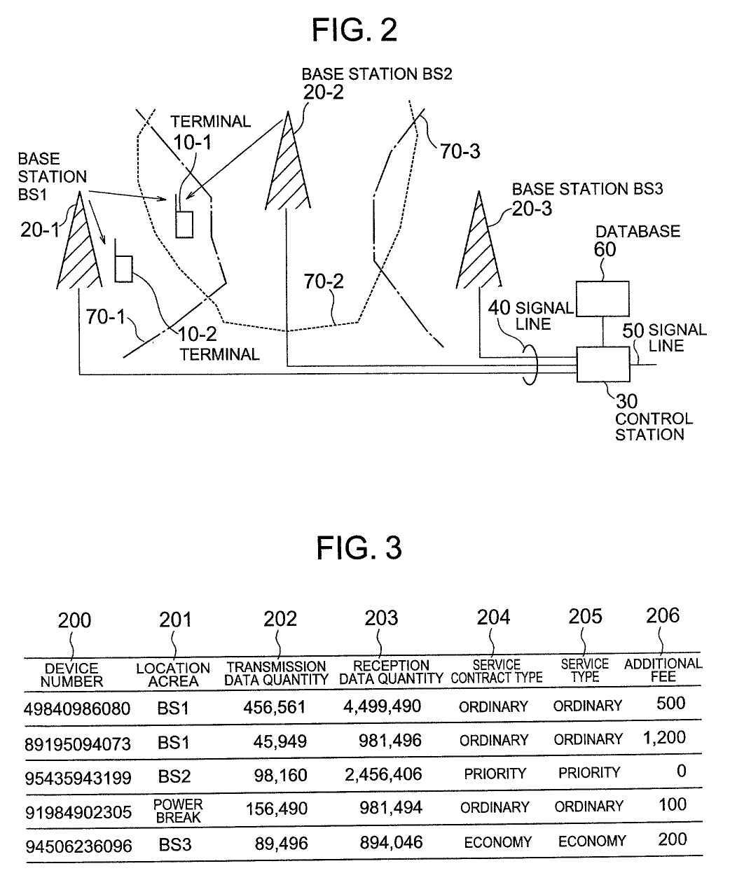

Hereinafter, explanation will be given on a communication system in which the present invention is applied to the HDR. FIG. 2 shows an entire configuration of the communication system according to the invention. The communication system includes a plurality of terminals 10 (10-1, 10-2), a plurality of base stations 20 (20-1, 20-2, 20-3), a control station 30, signal lines 40, 50 or a database 60.

The control station 30 is connected via the signal line 40 to the plurality of base stations 20. The control station 30 is connected via the signal line 50 to a data network (not depicted). The control station 30 receives data transmitted from the plurality of base stations 20 and transmits the data via the signal line 50 to the data network. On the contrary, the control stations 30 receives data via the signal line 50 from the data network and transmits the data to the plurality of the base stations 20. The control station 30 controls the plurality of base stations 20. The control station 30 is connected via a signal line to the database 60. The database 60 contains information related to the terminals.

Radio wave reach ranges 70 (70-1, 70-2, 70-3) are changed according to intensity of the power transmitted from the base stations 20. In general, when the power transmitted from the base stations 20 is made greater, the radio wave reaches farther, increasing the radio wave reach ranges 70. However, the radio wave reach ranges 70 are changed by the positional relationship between the base stations 20 or the power difference in the base stations and accordingly, the ranges 70 are not identical in size to each other. This is because the radio wave reach ranges 70 vary depending on the intensity of the radio wave transmitted from a local base stations 20, and an interference with a radio wave transmitted from other base stations 20. For example, the radio wave reach range 70-1 is decided by the intensity of the radio wave transmitted from the base station 20-1 and by the interference with the radio waves transmitted from the other base stations 20-2 and 20-3. Accordingly, for example, when the terminal 10-1 is located on the boundary between the radio wave reach range 70-1 and the radio wave reach range 70-2, switching between the base station 20-1 and the base station 20-2 for communication with the terminal 10-1 is repeatedly performed according to the intensity of the radio waves transmitted from the base station 20-1 and the base station 20-2 and according to the radio wave interference. Thus, the communication from the terminal 10-1 becomes unstable. In the communication system of the present invention, as the radio wave interference between the base station 20-1 and the base station 20-2 becomes greater, the C/I becomes smaller and the transmission rate from the base station 20-1 or the base station 20-2 to the terminal 10-1 becomes lower. By this low transmission rate, the terminal 101 can obtain a stable communication, assuring a preferable communication quality.

FIG. 3 shows information items held in the database 60 according to the present invention. A field for each of the terminals, for example, has information items of a device number 200, a location area 201, a transmission data quantity 202, a reception data quantity 203, a service contract type 204, a service type 205, or an additional charge 206.

The device number 200 is a number uniquely assigned to each of the terminals 10. For example, when the device number 200 is received from the control station 30, the database 60 transmits to the control station 30 the information indicated in the service type 205. The location area 201 indicates a base station controlling the terminal 10. For example, when the device number 200 of the terminal 10-2 is 89195094073 and the base station 20-1 is controlling the terminal 10-2, the location area 201 is BS1. In the location area 201, the base stations 20-1, 20-2, and 20-3 are indicated by BS1, BS2, and BS3, respectively. The transmission data quantity 202 is a data quantity transmitted by the terminal 10. The reception data quantity 203 is a data quantity received by the terminal 10. The transmission data quantity 202 or the reception data quantity 203 are used for charging and the like. The service contract type 204 indicates intensity of the transmission power of a down signal from the base station 20 to the terminal 10. The service contract type 204 is decided by a contract between a user of the terminal 10 and a provider of the communication system. The service contract type 204 is indicated for each of the terminals 10 according to the contract. For example, the service contract type 204 may be “economy”, “ordinary”, or “priority”. According to the service contract type 204, the transmission power of a down signal from the base station 20 to the terminal 10 becomes relatively larger in the order of “economy”, “ordinary”, and “priority”. The service type 205 represents intensity of the transmission power of a down signal from the base station 20 to the terminal 10 and a service type specified after the contract has been made. The service type 205 represents a current type after the contract has been made. Accordingly, when the service type is modified between a user of the terminal 10 and a provider of the communication system, the service type 205 shows the service type after the modification. For example, the service type 205 may be classified as “economy”, “ordinary” or “priority”. The intensity of the transmission power of a down signal from the base station 20 to the terminal 10 becomes relatively larger in the order of the “economy”, “ordinary”, and “priority” of the service type 205. The additional charge 206 shows, for example, an accumulated amount after additional charge has occurred, for example, in case the service type 205 is modified.

According to the present invention, the intensity of the transmission power of a down signal from the base station 20 to the terminal 10 is decided according to the service type 205 and accordingly, it is possible to assure a communication quality required by the user of the terminal 10. That is, the communication quality is not deteriorated indiscriminately as the distance from the base station to the terminal is increased. The present invention assures a communication quality requested by the user of the terminal 10 who always wants to have a better communication quality.

Hereinafter, explanation will be given on the communication system in which the present invention is applied to the HDR.

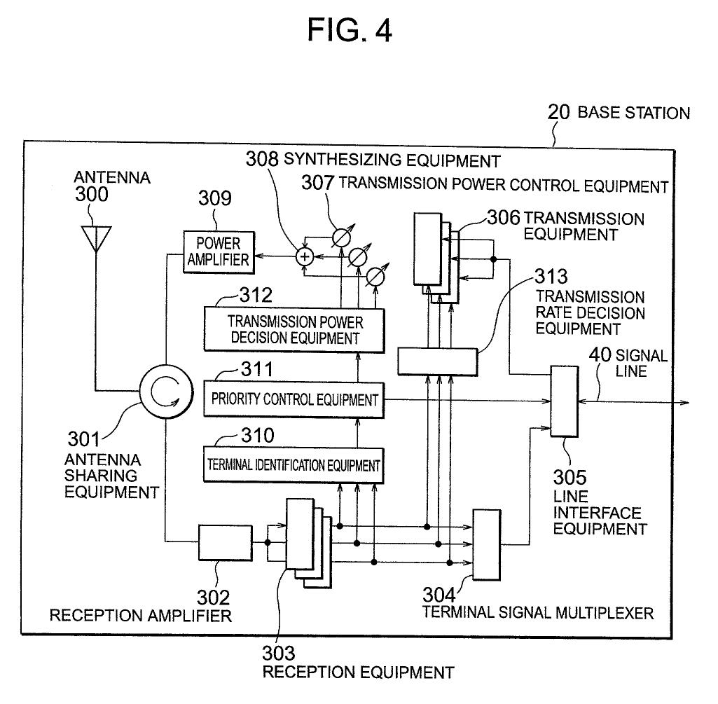

FIG. 4 is a block diagram of the base station 20 according to the present invention. The base station 20 receives a radio wave from the terminal 10 via an antenna 300. The received radio wave is sent via an antenna sharing equipment 301 to a reception amplifier 302. The reception amplifier 302 amplifies the radio wave to a sufficient intensity. The amplified radio wave is demodulated by a reception equipment 303 to an information signal. The reception equipment 303 consists of the same number of reception devices, for example, as the number of terminals controlled by the base station 20. In FIG. 4, there are three reception devices 303. The demodulated information signal is multiplexed with other demodulated information signal in a terminal signal multiplexer 304. The multiplexed information signals are sent to the control station 30 by a line interface equipment 305. The information signals are transmitted via the signal line 40 and the control station 30 to the data network.

On the other hand, an information signal received via the signal line 40 is received by the line interface equipment 305. The information signal received is encoded and modulated by a transmission equipment 306. The received information signal which has been encoded and modulated becomes a radio wave. The radio wave is controlled by a transmission power control equipment 307 so as to have an appropriate transmission power. The radio wave is multiplexed with other radio waves by a synthesizing equipment 308. The multiplexed radio waves are amplified by a power amplifier 309 so as to have a predetermined transmission power. The multiplexed radio waves are transmitted via the antenna sharing equipment 301 and the antenna 300 toward the terminal 10.

The information signal demodulated by the reception equipment 303 is supplied not only to the terminal signal multiplexer 304 but also to a transmission rate decision equipment 313. The transmission rate decision equipment 313 is connected to the transmission equipment 306. The transmission rate decision equipment 313 receives via the reception equipment 303 the carrier-to-interference power ratio C/I reported from the terminal 10. The transmission rate decision equipment 313 decides the transmission rate according to the carrier-to-interference power ratio C/I reported from the terminal 10. The transmission rate decision equipment 313 indicates the decided transmission rate to the transmission equipment 306. Here, the indication of the transmission rate includes, more specifically, indication of the modulation method and the processing gain. In this case, the transmission equipment 306 modifies the modulation method and the processing gain according to the indication from the transmission rate decision equipment 313.

For applying the present invention, the base station 20 also includes a terminal identification equipment 310, a priority control equipment 311 or a transmission power decision equipment 312. The information signal which has been demodulated by the reception equipment 303 is supplied not only to the terminal signal multiplexer 304 but also to the terminal identification equipment 310. The terminal identification equipment 310 is connected to the priority control equipment 311. When a connection from a terminal 10 to the base station 20 is requested, the terminal identification equipment 310 identifies the device number 200 of the terminal 10. The device number 200 identified is transmitted to the priority control equipment 311.

The priority control equipment 311 is connected not only to the terminal identification equipment 310 but also to the line interface equipment 305 or the transmission power decision equipment 312. The priority control equipment 311 generates a query signal to be sent to the database 60 according to the device number 200 supplied. The priority control equipment 311 transmits a query signal for service type to the line interface equipment 305. The query signal is transmitted from the line interface equipment 305 via the signal line 40 or the control station 30 to the database 60. The priority control equipment 311 receives the service type 205 of the terminal 10 from the database 60 via the control station 30, the signal line 40, or the line interface equipment 305. The priority control equipment 311 measures a communication start time of the terminal 10. Here, the priority control equipment 311 holds the device number 200, information related to the communication start time or the service type 205 of the terminal 10. The priority control equipment 311 transmits the service type 205 to the transmission power decision equipment 312.

The transmission power decision equipment 312 receives the service type 205 from the priority control equipment 311. The transmission power decision equipment 312 decides a transmission power according to the service type 205. The transmission power decision equipment 312 specifies a radio wave transmission with the transmission power decided for the transmission power control equipment 307. The transmission power control equipment 307 controls the transmission power to the terminal 10 according to the specified transmission power. For example, the instruction of the transmission power decision equipment 312 maintains the transmission power as it is if the service type 205 is “ordinary”, and increases the power transmission by 3 dB if the service type 205 is “priority”, and decreases the transmission power by 3 dB if the service type 205 is “economy”.

It should be noted that the terminal identification equipment 310, the priority control equipment, or the transmission power decision equipment are constituted by using a CPU (central processing unit) in combination with an ROM (read-only memory), an RAM (random access memory), and the like, as is necessary.

According to the present invention, the base station 20 employs the TDMA. For this, there is no problem that the processing load of the base station is increased as is described in the Japanese Patent Publication 2001-36463. That is, according to the present invention, by using the TDMA, a terminal 10 can instantaneously occupy the entire band. Consequently, according to the present invention, there is no need of load for observing the total of transmission power of down signals transmitted to all the terminals 10.

It should be noted that the present invention can modify the transmission rate for both of a down signal from the base station to the terminal 10 and an up signal from the terminal 10 to the base station 20. However, this technique is identical, for example, to the HDR and its explanation is omitted here. That is, although not explained in the aforementioned explanation, the base station 20 has means for changing the transmission rate of data transmitted to the terminal 10. Moreover, the terminal 10 has means for changing the transmission rate of data transmitted to the base station 20.

According to the present invention, it is possible to change the transmission rate as in the HDR and accordingly, it is possible to transmit more data from a base station to a terminal. That is, it is possible to communicate at a high rate with a terminal having a preferable communication state or it is possible to communicate at a high rate with a terminal which requires only a low transmission rate. Thus, communication from the base station to the terminal can be completed in a short time, thereby enabling effective use of communication resources.

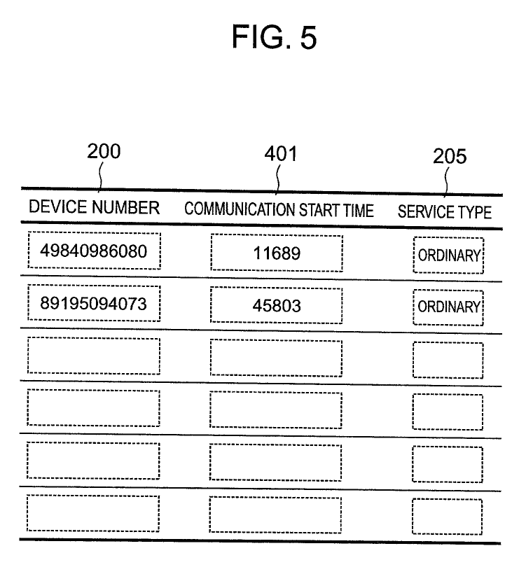

FIG. 5 shows information items stored in the priority control equipment 311 of the base station 20 according to the present invention. The items stored are: the device number 200, a value 401 decided according to a communication start time, or the service type 205. The priority control equipment 311 has for each of the terminals 10: the device number 200, the value 401 decided according to a communication start time, or the service type 205.

The value 401 decided according to a communication start time is calculated, for example according to [Equation 1]. The value 401 decided according to a communication start time is T, which represents seconds based on 0 hour, 0 minute, and 0 second.

T={(hh×60)+mm}×60+ss [Equation 1]

wherein hh, mm, and ss, represent hours, minutes, and seconds, respectively. The hh, mm, ss are values accumulated from 0 hour, 0 minute, 0 second. For example, if a communication starts at 8 o'clock 20 minutes, 40 seconds, hh, mm, ss, are 8, 20, and 40, respectively.

When a connection is requested from a terminal 10 to the base station 20, the priority control equipment 311 adds a storage area for the device number 200, the value 401 indicating the communication start time, or the service type 205 of the terminal 10 at the end of the respective storage items shown in FIG. 5. Moreover, when a communication end is requested from the terminal 10 to the base station 20, the priority control equipment 311 deletes the storage area added for the terminal 10.

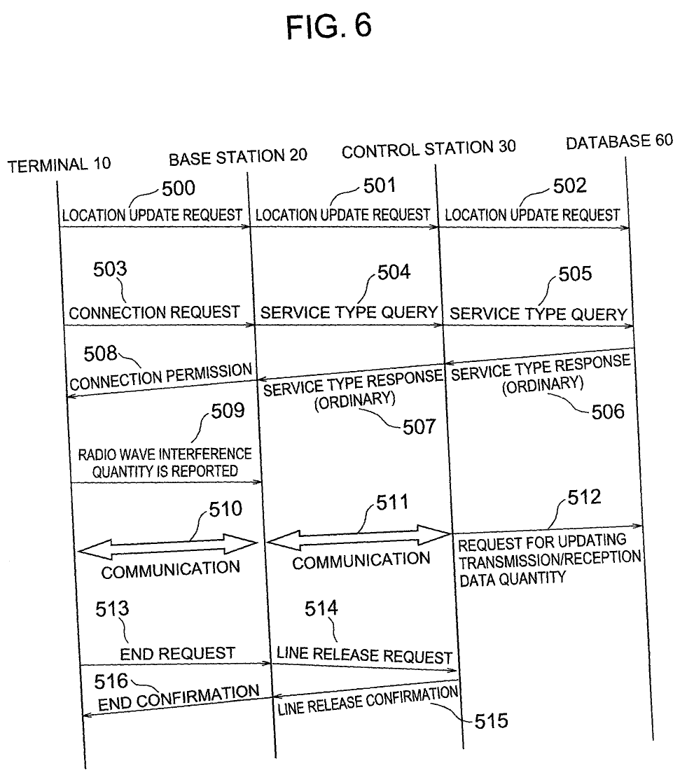

Hereinafter, an explanation will be given on a case when the service type 205 is not changed. FIG. 6 shows a communication sequence of the present invention. Referring to FIG. 6, explanation will be given on the communication sequence of the present invention. A terminal 10 requests a location update to a base station 20 (step 500). When the location update is requested, the base station 20 sends a request for the location update to the control station 30 (step 501). Here, the base station 20 sends the location update request to the control station 30 via the antenna 300, the antenna sharing equipment 301, the reception amplifier 302, the reception equipment 303, the terminal signal multiplexer 304, or the line interface equipment 305 shown in FIG. 4. When the location update is requested, the control station 30 sends the location update request to the database 60 (step 502). When the location update is requested, the database 60 updates the local area 201 shown in FIG. 3 according to the device number 200 received together with the location update request.

The terminal 10 sends a connection request to the base station 20 (step 503). When the connection is requested, the base station 20 asks the control station about the service type (step 504). Here, the priority control equipment 311 shown in FIG. 4 adds a storage area for the device number 200, the communication start time indicating value 401, or the service type 205 at the end of the respective storage items shown in FIG. 5. When the service type 205 is asked, the control station 30 asks the database 60 about the service type 205 (step 505). When the service type is asked, the database 60 retrieves the service type 205 shown in FIG. 3 according to the device number 200 received together with the query for the service type. The database 60 reports the retrieved service type 205 to the control station 30 (step 506). For example, when the database 60 identifies the service type 205 as “ordinary” the database 60 reports it to the control station 30. The control station 30 answers the service type 205 to the base station 20 (step 507). Furthermore, the control station 30 establishes a communication line between the control station 30 and the base station 20. When the service type 205 is answered, the base station 20 decides the transmission power to the terminal 10. The base station 20 allows the terminal 10 connection by using the decided transmission power (step 508).

When the connection is allowed, the terminal 10 reports the radio wave interference quantity to the base station 20 (step 509). Here, the radio wave interference quantity is, for example, the C/I. When the radio wave interference quantity is reported, the base station 20 decides a transmission rate of a down signal from the base station 20 to the terminal 10 according to the radio wave interference quantity. Communication between the terminal 10 and the base station 20 is started with the decided transmission rate (step 510). During the communication between the terminal 10 and the base station 20, the terminal 10 repeatedly reports the radio wave interference quantity to the base station 20 (step 509). The base station 20 repeatedly decides the transmission rate of the down signal from the base station to the terminal 10. Reporting of the radio wave interference quantity or decision of the transmission rate are repeatedly performed until the communication is completed. Thus, even when the interference state is changed during the communication between the terminal 10 and the base station 20, an appropriate transmission rate can be used for the communication. The base station 20 communicates with the terminal 10 according to step 510 and also communicates with the control station 30 (step 511). According to the communication with the base station 20, the control station 30 measures the transmission data quantity 202 transmitted from the terminal 10 or the reception data quantity 203 received by the terminal 10. After the control station 30 has measured the transmission data quantity 202 or the reception data quantity 203, the control station 30 requests the database 60 to update the transmission data quantity 202 or the reception data quantity 203 (step 512). When the database 60 receives an update request from the control station 30, the database 60 updates the transmission data quantity 202 or the reception data quantity 203 shown in FIG. 3 according to the device number 200 received together with the request for updating the transmission data quantity 202 or the reception data quantity 203.

The terminal 10 requests the base station 20 to terminate the communication (step 513).

When the communication end is requested from the terminal 10, the base station 20 requests the control station 30 to release the communication line (step 514). When the communication line release is requested, the control station 30 confirms the communication line release requested from the base station 20 (step 515). When the communication line release is confirmed, the base station 20 checks the terminal 10 whether the communication is to be terminated (step 516). When the communication end is confirmed, the series of communication from the terminal 10 is terminated.

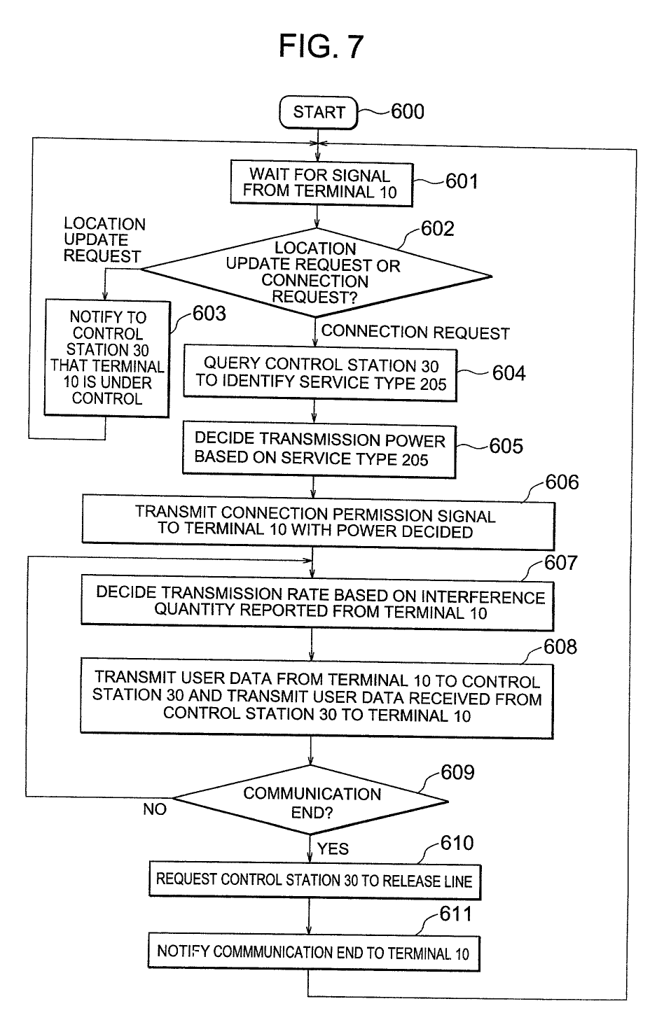

FIG. 7 is a flowchart of the processing of the base station 20 according to the present invention. Referring to FIG. 7, explanation will be given on the processing of the base station 20 of the present invention. In the initial state, the flowchart is started (step 600). The base station 20 waits for reception of a radio wave transmitted from a terminal 10. When a radio wave is received from a terminal 10, the base station 20 decides whether the radio wave indicates a request for location update or request for connection (step 602). The location update request in step 602 corresponds to step 500 in FIG. 6 and the connection request in step 602 corresponds to step 503 in FIG. 6. If the radio wave indicates a location update request in step 602, the base station 20 sends the location update request to the control station 30 according to step 501 shown in FIG. 6. More specifically, for example, the base station 20 reports to the control station 30 that the terminal 10 is under control of the local base station or the local base station controls the terminal 10 (step 603). Here, the base station 20 receives the device number 200 of the terminal 10. The device number 200 received is transmitted together with the location update request to the control station 30. When the location update is requested, the base station 20 returns to the wait state for a radio wave from a terminal 10 (step 601).

In step 602, if a radio wave for a connection request is received, the base station 20 asks the control station 30 about the service type 205 according to step 504 shown in FIG. 6 (step 604). Here, the base station 20 receives the device number 200 of the terminal 10 using the terminal identification equipment 310 shown in FIG. 4. The received device number 200 is transmitted via the priority control equipment 311 or the line interface equipment 305 to the control station 300 together with the query for service type. The priority control equipment 311 adds the device number 200, the communication start value 401, or the service type 205 of the terminal 10 to the end of each of the storage items shown in FIG. 5.

When the service type 205 is answered according to step 507 in FIG. 6, the base station 20 decides the transmission power to the terminal 10 (step 605). Here, in the base station 20, the priority control equipment 311 shown in FIG. 4 receives the service type 205 via the line interface equipment 305. The priority control equipment 311 transmits the service type 205 to the transmission power decision equipment 312. The transmission power decision equipment 312 decides a transmission power according to the service type 205. The transmission power decision equipment 312 indicates the transmission power control equipment 307 to transmit a radio wave with the decided transmission power. The transmission power control equipment 307 sets a transmission power to the terminal 10 according to the specified transmission power.

The base station 20 transmits a connection allow signal to the terminal 10 using the transmission power decided (step 606). Step 606 corresponds to step 508 shown in FIG. 6.

According to step 509 shown in FIG. 6, the base station 20 receives a report on the radio wave interference quantity from the terminal 10. The radio wave interference quantity is, for example, C/I. When the radio wave interference quantity is reported, the base station 20 decides a transmission rate of a down signal from the base station 20 to the terminal 10 (step 607). According to the transmission rate decided, the base station 20 transmits a radio wave to the terminal 10. Until the communication is terminated, the base station 20 repeatedly decides a transmission rate of the down signal to the terminal 10 according to the radio wave interference quantity. The transmission rate decision equipment 313 of the base station 20 decides a modulation method and a processing gain according to the C/I transmitted from the terminal 10. The transmission rate decision equipment 313 assumes that as the C/I increases, the communication state becomes better, and selects a higher-multi-value modulation or a lower processing gain. For example, when the C/I is 10 dB, the transmission rate decision equipment 313 selects the 16 QPSK (16-value) modulation method and 0 dB processing gain and decides a transmission rate of 2.4 Mbit/s. When the C/I is 0 dB, the transmission rate decision equipment 313 selects the QPSK (4-value) modulation method and 0 dB processing gain and decides a transmission rate of 614 kbit/s. When the C/I is − (minus), the transmission rate decision equipment 313 selects the QPSK (4-value) modulation method and 12 dB processing gain and decides a transmission rate of 38.4 kbit/s.

The base station 20 receives data transmitted by a user of the terminal 10 according to step 510 shown in FIG. 6. The base station 20 transmits the data to the control station 30 according to step 511 shown in FIG. 6. In the reverse data flow, the base station 20 receives data from the control station 30 which has been transmitted by a user of a communication partner of the terminal 10 according to step 511 shown in FIG. 6. The base station 20 transmits the data to the terminal 10 according to step 510 shown in FIG. 6. Step 608 shows data processing between the terminal users in the base station 20. According to step 513 shown in FIG. 6, the base station 20 repeats the processes of steps 607 and 608 until a communication end is requested from the terminal 10 (step 609).

When a communication end is requested from the terminal 10, the base station 20 decides that the communication is terminated (step 609). When the communication end is requested from the terminal 10 at step 609, the base station 20 requests the control station 30 to release the communication line (step 610). Step 610 corresponds to step 514 shown in FIG. 6. When the communication end is requested from the terminal 10 in step 609, the priority control equipment 311 shown in FIG. 4 deletes the storage area added in step 604.

When the base station 20 has confirmed release of the communication line according to step 515 shown in FIG. 6, the base station 20 reports the communication end to the terminal 10 as confirmation of the communication end (step 611). Step 611 corresponds to step 516 shown in FIG. 6. After the base station reports the communication end to the terminal 10, the base station 20 enters a wait state for a radio wave transmitted from a terminal 10 (step 601).

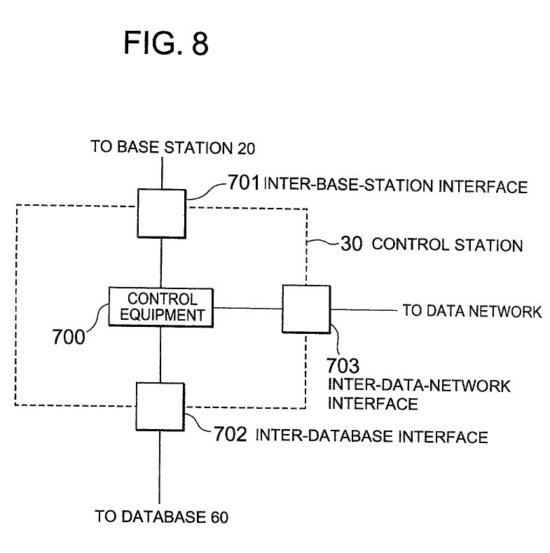

FIG. 8 is a block diagram of the control station 30 of the present invention. The control station 30 has a control equipment, an inter-base-station interface 701, an inter-database interface 702, an inter-data-network interface 703, or other equipment (not depicted). The control station 30 is connected to the base station 20 via the inter-base-station interface 701. The control station 30 is connected to the database 60 via the inter-database interface 702. The control station 30 is connected to the data network via the inter-data-network interface 703. The control equipment 700 is connected to the inter-base-station interface 701, the inter-database interface 702, or the inter-data-network interface 703. The control equipment 700 controls the control station 30. It should be noted that the control equipment 700 is constituted by a CPU, ROM, RAM, and the like in combination.

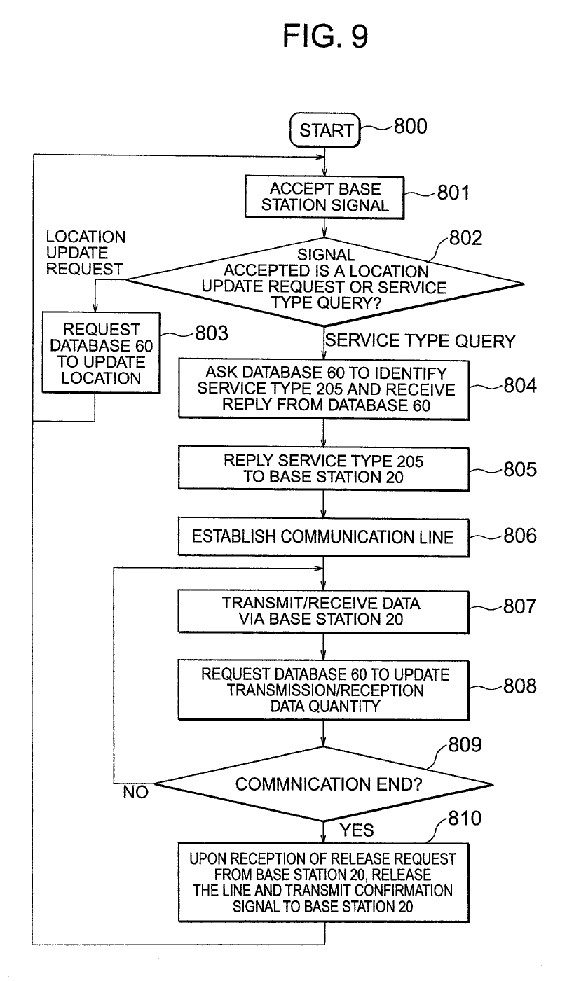

FIG. 9 is a flowchart of processing of the control equipment 700 of the present invention. Referring to FIG. 9, explanation will be given on the flowchart of the processing of the control equipment 700 of the present invention. In an initial state, the flowchart is started (step 800). The control station 30 receives a signal transmitted from the base station 20 (step 801). Upon acceptance of the signal, the control station 30 checks whether the signal is a location update request or a service type query (step 802). The location update request in step 802 corresponds to step 501 shown in FIG. 6. The service type query in step 802 corresponds to step 504 shown in FIG. 6.

If step 802 decides that the signal is a location update request, then the control station 30 requests the database 60 to perform location update according to step 502 shown in FIG. 6 (Step 803). Here, the control station 30 receives the device number 200 of the terminal 10. The device number 200 received is transmitted to the database 60 together with the location update request. After requesting the location update, the control station 30 returns to a signal wait state for a signal transmitted from the base station 20 (step 801).

If step 802 decides that the signal is a service type query, then the control station 30 asks the database 60 about the service type 205 according to step 505 shown in FIG. 6 (step 804). Here, the control station 30 receives the device number 200 of the terminal 10. The device number 200 received is transmitted to the control station 30 together with the service type query. The control station 30 receives a response about the service type 205 from the database 60 according to step 506 shown in FIG. 6.

Upon reception of the response about the service type 205, the control station 30 reports the service type 205 to the base station 20 according to step 507 shown in FIG. 6 (step 805). The control station 30 establishes a communication line with the base station 20 (step 806).

According to step 511 shown in FIG. 6, the control station 30 receives via the base station 20, the data transmitted by a user of the terminal 10. The control station 30 transmits the received data to the data network. In the reverse data flow, the control station 30 receives via the data network the data transmitted by a user of the communication partner of the terminal 10. According to step 511 shown in FIG. 6, the control station 30 transmits to the base station, the data received via the data network. Step 807 shows data processing between the users of the terminals in the control station 30.

According to the communication with the base station 20, the control station 30 measures a transmission data quantity 202 transmitted from the terminal 10 or a reception data quantity 203 received by the terminal 10. When the control station 30 has measured the transmission data quantity 202 or the reception data quantity 203, the control station 30 requests the database 60 to update the transmission data quantity 202 or the reception data quantity 203. The request for updating the transmission data quantity 202 or the reception data quantity 203 corresponds to step 512 shown in FIG. 6.

According to step 514 shown in FIG. 6, the control station 30 repeats the processes of steps 807 and 808 until a communication line release is requested from the base station 20 (step 809).

When the communication line release is requested from the base station 20, the control station 30 decides that the communication is terminated (step 809). When the communication line release is requested from the base station 20 in step 809, the control station 30 releases the communication line (step 810). When the control station 30 has released the communication line, the control station 30 transmits a communication line release confirmation signal to the base station 20. Step 810 corresponds to step 515 or 516 shown in FIG. 6. After releasing the communication line, the control station 30 returns to a signal wait state for a signal transmitted from the base station 20 (step 801).

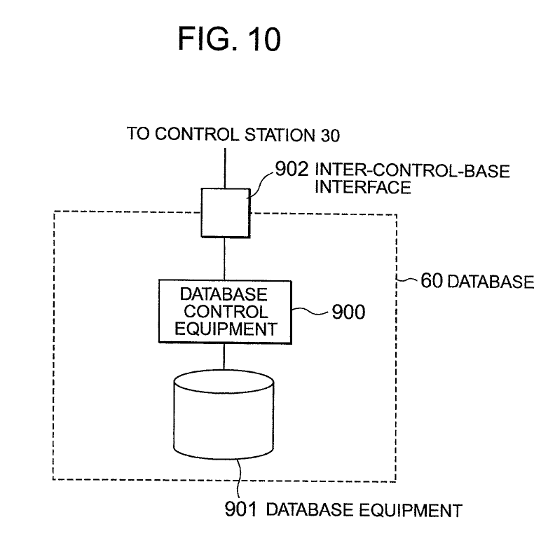

FIG. 10 is a block diagram of the database 60 of the present invention. The database 60 includes: a database control equipment 900, a database equipment 901, inter-control-station interface 902, or the like (not depicted). The database 60 is connected to the control station 30 via the inter-control-station interface 902. The database control equipment 900 is connected to the inter-control-station interface 902 or the database equipment 901. The database control equipment 900 controls the database 60. More specifically, the database control equipment 900 retrieves data in the database equipment 901 according to a signal transmitted from the control station 30 and replies to the control station 30. The database equipment 901 stores items shown in FIG. 3 or data related to these items. It should be noted that the database control equipment 900 is constituted by a CPU, ROM, RAM and the like in combination. The database equipment 901 is a storage device such as RAID (redundant array of inexpensive disks).

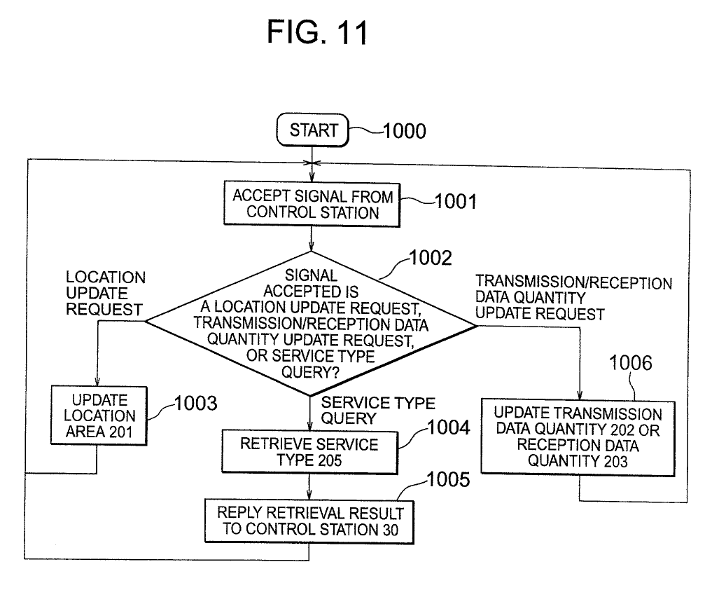

FIG. 11 is a flowchart of the processing of the database control equipment 900 of the present invention. Referring to FIG. 11, explanation will be given on the processing flowchart of the database control equipment 900 of the present invention. In an initial state, the flowchart is started (step 1000). The database 60 accepts a signal transmitted from the control station 30 (step 1001). Upon acceptance of the signal, the database 60 decides whether the signal is a location update request, a request for updating the transmission data quantity 202 or the reception data quantity 203, or a query for service type (step 1002). The location update request in step 1002 corresponds to step 502 shown in FIG. 6. The request for update of transmission data quantity 202 or the reception data quantity 203 in step 1002 corresponds to step 512 shown in FIG. 6. The service type query in step 1002 corresponds to step 505 shown in FIG. 6.

If step 1002 results in that the signal is a location update request, the database 60 updates the location area 201 shown in FIG. 3 (step 1003). The database 60 receives the device number 200 of the terminal 10 together with the location update request. According to the device number 200 of the terminal 10, the database 60 updates the location area 201 stored in the database equipment 901. For example, when the base station 20-1 shown in FIG. 2 is controlling the terminal 10, the location area 201 is updated to BS1. After updating the location area 201, the database 60 returns to the wait state for a signal transmitted from the control station 30 (step 1001).

If step 1002 results in that the signal is a service type query, the database 60 retrieves the service type 205 by using the database equipment 901 (step 1004). The database 60 receives the device number 200 of the terminal 10 together with the service type query. According to the device number 200 of the terminal 10, the database 60 retrieves the service type 205 stored in the database equipment 901. According to step 506 shown in FIG. 6, the database 60 replies the retrieved service type 205 to the control station 30 (step 1005). For example, if the device number 205 of the terminal 10 is 89195094073, the database 60 replies “ordinary” as shown in FIG. 3. After replying the service type 205 retrieved, the database 60 returns to the wait state for a signal transmitted from the control station 30 (step 1001).

If step 1002 results in that the signal is a request for updating the transmission data quantity 202 or the reception data quantity 203, the database 60 updates the transmission data quantity 202 or the reception data quantity 203 stored in the database equipment 901 (step 1006). The database 60 receives the device number 200 of the terminal 10 together with the update request of transmission data quantity 202 or the reception data quantity 203. According to the device number 200 of the terminal 10, the database 60 updates the transmission data quantity 202 or the reception data quantity 203 corresponding to the device number 200. After updating the transmission data quantity 202 or the reception data quantity 203, the database 60 returns to the wait state for a signal transmitted from the control station 30 (step 1001).

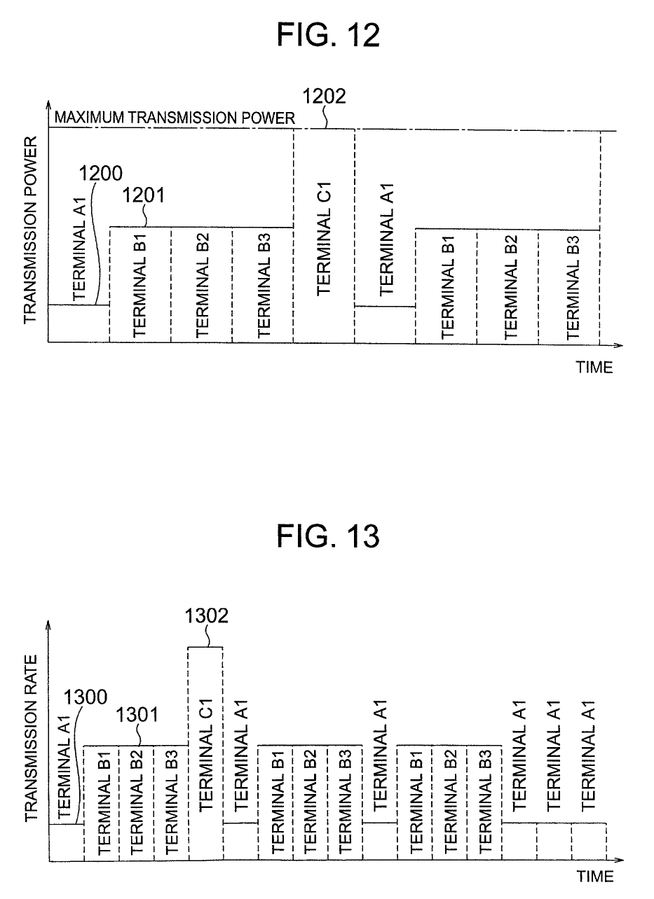

FIG. 12 shows a change of electric power transmitted from the base station 20 to the terminal 10 along time according to the present invention. In FIG. 12, the vertical axis represents the transmission power of a down signal from the base station 20 to the terminal 10. The horizontal axis represents time. In FIG. 12, five users respectively use terminals 10 (A1, B1, B2, B3, C1). These five terminals are controlled by a single base station 20. The base station 20 transmits data to the terminals 10 by using a packet slot time-divided by the TDMA. The transmission powers from the base station 20 to the five terminals 10 are different according to the service type 205 of the respective terminals 10. For example, terminals 10-A1, 10-B1, 10-B2, 10-B3, or 10-C1 have service type 205 as “economy”, “ordinary”, “ordinary”, “ordinary”, or “priority”, respectively. The transmission power of down signals from the base station 20 to the terminals 10 relatively increases in the order of “economy”, “ordinary”, and “priority”. Here, the transmission power 1200 from the base station 20 to the terminal 10-A1 is smaller than the transmission power 1201 to the terminals 10-B1, 10-B2, or 10-B3. The transmission power 1201 from the base station 20 to the terminals 10-B1, 10-B2, or 10-B3 is smaller than the transmission power 1202 to the terminal 10 Cl. For the terminal 10-C1 having the service type 205 of “priority”, for example, it is possible to allocate a maximum transmission power to be transmitted from the base station 20 to the terminal 10.

According to the present invention, it is possible to assure a communication quality according to the communication quality requested from a user of the terminal 10 to the communication system provider. This enables the communication system provider to provide a stable communication quality requested by a user in the public communication which may be urgent in case of fire fighting and prevention of disasters. That is, when the terminal 10 is on a boundary of the radio wave reach range, a frequent hand-over has caused an instantaneous communication data loss, making the communication unstable. However, according to the present invention, even when the terminal 10 is on the boundary of the radio wave reach range, the communication quality requested by a user of the terminal 10 can be assured. Moreover, the communication system provider can change the charge according to the communication quality. Users can use the communication system at a low cost when no urgent communication is requested as compared when urgent communication is required. It should be noted that the urgent public communication occurs when transmitting data of telemeter installed in a flooding river, or when transmitting a video data of the area of disasters.

Explanation has been given on the transmission power from the base station 20 to the terminal 10 when the power is increased in the order of “economy”, “ordinary” and “priority” of the service type 205. However, the present invention is not limited to such a case but can also be applied when a transmission rate of a down signal from the base station 20 to the terminal 10 becomes relatively greater in the order of “economy”, “ordinary”, and “priority”. Here, the transmission rate 1300 from the base station 20 to the terminal 10-A1 is lower than the transmission rate to the terminals 10-B1, 10-B2, or 10-B3. The transmission rate 1301 from the base station 20 to the terminals 10-B1, 10-B2, or 10-B3 is lower than the transmission rate 1302 to the terminal 10-C1. Here, it is assumed that the data quantities transmitted from the base station 20 to the five terminals are identical. In this case, as the transmission rate from the base station 20 to the terminal 10 increases, the communication from the base station 20 to the terminals 10 can be completed in a shorter time. Accordingly, the communication from the base station 20 to the terminal 10-A1 needs a longer time than the communication to the terminals 10-B1, 10-B2, or 10-B3. The communication from the base station 20 to the terminals 10-B1, 10-B2, or 10-B3 needs a longer time than the communication to the terminal 10-C1. That is, after the communication from the base station 20 to the terminal 10-Cl is completed, the communication from the base station 20 to the terminals 10-B1, 10-B2, or 10-B3 is completed. After this, the communication from the base station 20 to the terminal 10-A1 is completed. FIG. 13 shows a transmission rate change along time from the base station 20 according to the present invention. In FIG. 13, the vertical axis represents a transmission rate of a down signal from the base station 20 to the terminal 10. The horizontal axis represents time.

According to the present invention, it is possible to assure a requested transmission rate according to a transmission rate requested from a user of the terminal 10 to the communication system provider. Thus, the communication system provider can provide a high-rate transmission requested by a user in public communication paying much attention on urgency of fire fighting, prevention of disasters, and the like. That is, according to the present invention, it is possible to assure a high-rate transmission requested by a user of the terminal 10. Moreover, the communication system provider can change the charging system according to the transmission rate. The user can use the communication system at low cost when no urgency is required as compared to a case when urgency is required. The user can use the communication system at a low cost when no high-rate transmission is required as compared when a high-rate transmission is required.

In the aforementioned embodiment, the service type 205 has been explained in a three-type classification “economy”, “ordinary”, and “priority”. However, the present invention is not limited to this classification and can be applied to any of classification of the service type 205 such as two or more types.

Explanation thus far has been given on a case that the service type 205 is not changed. In contrast to this, hereinafter, explanation will be given on a case that the service type is changed after a contract has been made between a user of the terminal 10 and the communication system provider.

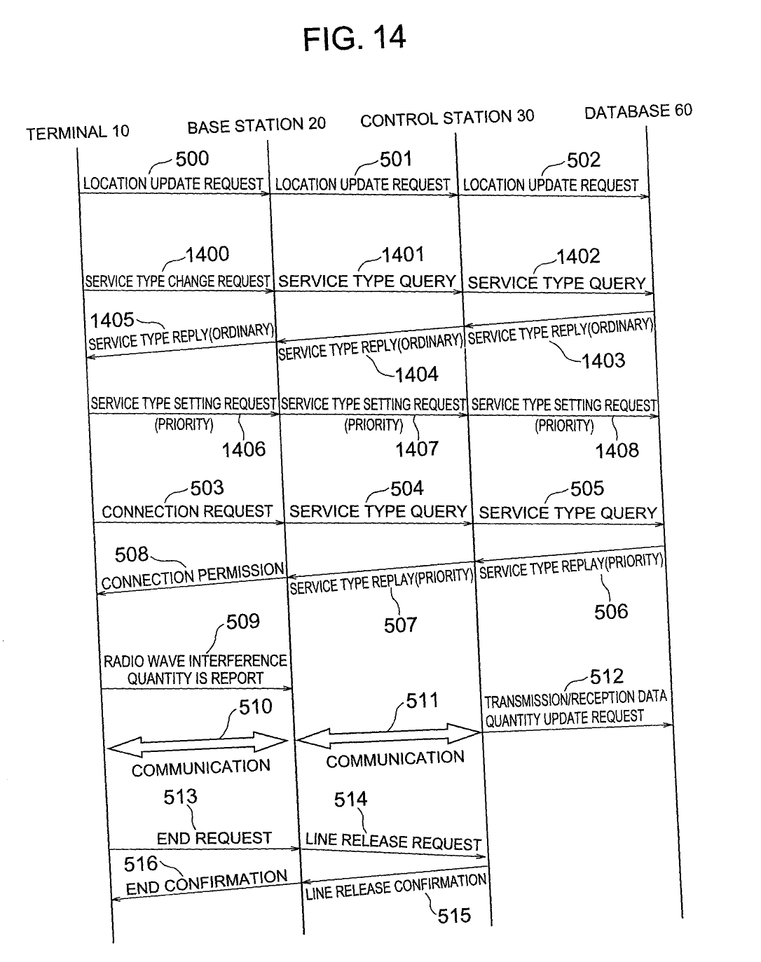

FIG. 14 shows a communication sequence in the present invention. Referring to FIG. 14, explanation will be given on the communication system of the present invention. As compared to the communication sequence in FIG. 6, the communication sequence of FIG. 14 additionally has step 1400 to step 1408.

The terminal 10 requests a change of the service type 205 to the base station 20 (step 1400). When the change of the service type 205 is requested, the base station 60 asks the control station 30 about the service type 205 (step 1401). When the service type 205 is asked, the control station 30 asks the database 60 about the service type 205 (step 1402). When the service type 205 is asked, the database 60 retrieves the service type 205 shown in FIG. 3 according to the device number 200 received together with the query for the service type. The database 60 replies the retrieved service type 205 to the control station 30 (step 1403). For example, the database 60 replies the service type 205 as “ordinary” to the control station 30. When the service type 205 is replied, the control station 30 replies the service type 205 to the base station 10 (step 1404). When the service type 205 is replied, the base station 20 replies the service type 205 to the terminal 10 (step 1405).

The user of the terminal 10 changes the service type 205 at the terminal 10. When the service type 205 is changed, the terminal 10 requests the base station 20 to set the service type 205 (step 1406). For example, the terminal 10 requests the base station 20 to set the service type 205 to “priority”. When setting of the service type 205 is requested, the base station 20 requests the control station 30 to set the service type 205 (step 1407). When setting of the service type 205 is requested, the control station 30 requests the database 60 to set the service type 205 (step 1408). When setting of the service type 205 is requested, the database 60 sets the requested service type 205. For example, the database 60 changes the service type 205 from “ordinary” to “priority”. After this, when a connection request is made from the control station 30 according to step 505, the database 60 replies the updated service type 205 to the control station 30 (step 506). For example, the database 60 replies “priority” as the service type 205 to the control station 30. When the changed service type 205 is replied, the control station 30 replies the changed service type 205 to the base station 20 (step 507). For example, the control station 30 replies “priority” as the service type 205 to the base station 20. When the changed service type 205 is replied, the base station 20 decides a transmission power to the terminal 10 according to the changed service type 205. For example, the base station 20 decides the transmission power to the terminal 10 according to the service type 205 as “priority”. The base station 20 allows a connection to the terminal 10 using the transmission power decided according to the changed service type 205 (step 508).

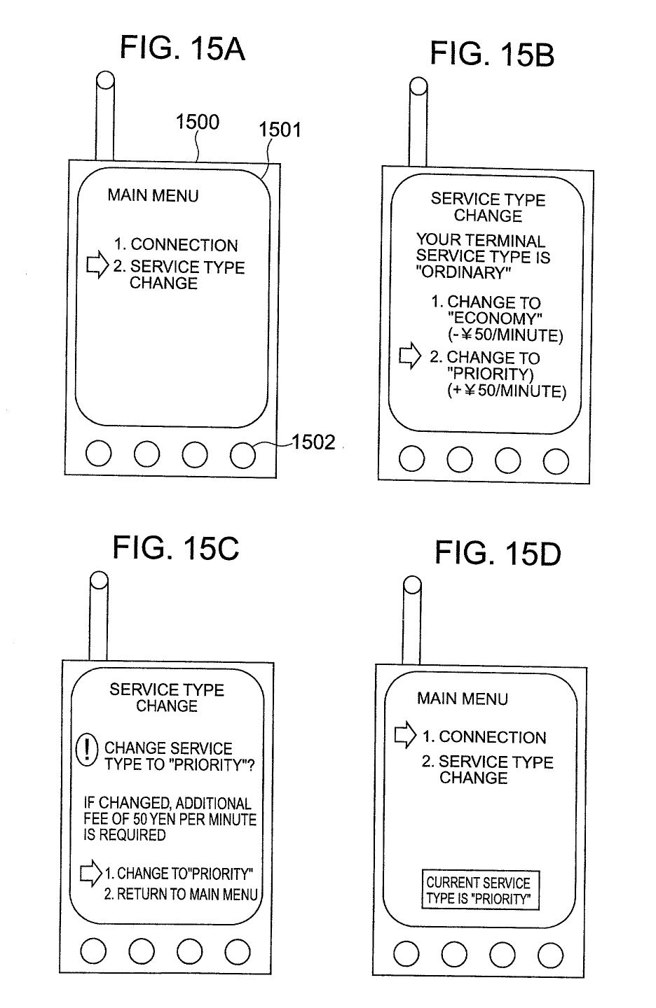

FIGS. 15A-15D shows an example of a display screen of the terminal 10 when changing the service type in the present invention. Referring to FIGS. 15A-15D, explanation will be given on the display screen of the terminal 10. A frame 1500 of the terminal 10 has a liquid crystal touch panel 1501. FIG. 15A shows a display example of the main menu display screen. On this main menu display screen, the user of the terminal 10 can select a connection menu or a service type change menu. The user of the terminal 10 can select one of the menus by touching the touch panel 1501. On the main menu display screen, the user of the terminal 10 selects the service type change menu. When the user of the terminal 10 selects the service type change menu, according to step 1400 shown in FIG. 14, a change of the service type 205 is requested from the terminal 10 to the base station 20. When the service type 205 is replied from the base station 20 to the terminal 10 according to step 1405 shown in FIG. 14, the display screen is changed from the main menu display screen to a display screen of FIG. 15B.

FIG. 15B shows a display example of a service type change menu. On the display screen of the service type change menu, the service type 205 of the terminal 10 is displayed. On the display screen of the service type change menu, the user of the terminal 10 can select a change menu of the service type 205. For example, when the current service type 205 is “ordinary”, the user of the terminal 10 can select a menu to change to “economy” or a menu to change to “priority”. On the display screen of the service type change menu, an additional fee is displayed for the changed menu of the service type 205. For example, for the menu to change the service type 205 to “economy” − (minus) ¥50/minute is displayed. For the menu to change the service type 205 to “priority”, + (plus) ¥50/minute is displayed. Here, the − (minus) ¥50/minute means an additional fee that the charge per minute is 50 yen cheaper as compared to the case when the service type 205 is not changed. The + (plus) ¥50/minute means an additional fee that the charge per minute is 50 yen higher as compared to the case when the service type 205 is not changed. On the display screen of the service type change menu, the user of the terminal 10 selects a menu to change the service type 205 to “priority”. Then, the display screen of the service type change menu is changed to the display screen of FIG. 15C.

FIG. 15C shows a display example of the display screen for confirming the change of the service type 205 of the terminal 10. For example, FIG. 15C is a menu display screen to change the service type 205 to “priority”. The display screen of FIG. 15C is used to confirm the change of the service type 205 to “priority”. For example, the display screen of FIG. 15C shows a message “Change the service type to “priority?””. On the display screen of FIG. 15C, the additional fee required for change of the service type is also displayed. For example, the display screen shows a message “When changed, additional fee of 50 yen per minute is required”. On the display screen of FIG. 15C, the user of the terminal 10 can select a menu for changing the service type 205 to “priority” or a menu to return to the main menu display screen. On the display screen of FIG. 15C, if the user of the terminal 10 selects the menu to return to the main menu, the display screen of FIG. 15C is changed back to the display screen of FIG. 15A. When the user of the terminal 10 selects the menu to return to the main menu, step 1406 shown in FIG. 14 is not executed.

In contrast to this, on the display screen of FIG. 15C, if the user of the terminal 10 selects the menu to change the service type 205 to “priority”, then the display screen of FIG. 15C is changed to the display screen of FIG. 15D. The display screen of FIG. 15D is different from the display screen of FIG. 15A in that “priority” is displayed as the service type. For example, FIG. 15D shows a message “use “priority””. When the user of the terminal 10 selects a menu to change the service type 205 to “priority”, according to step 1406 shown in FIG. 14, an update of the service type 205 is requested from the terminal 10 to the base station 20. It should be noted that on the display screen of FIG. 15C, when the user of the terminal 10 has selected a menu to change the service type 205 to “priority”, the display screen may be changed back to the display screen of FIG. 15A instead of the display screen of FIG. 15D.

Moreover, explanation has been given on an embodiment in which a menu selected by the user of the terminal 10 is accepted through the touch panel 1501. However, the present invention is not limited to this embodiment but the menu can also be accepted through a button 1502 or a rotary button (not depicted).

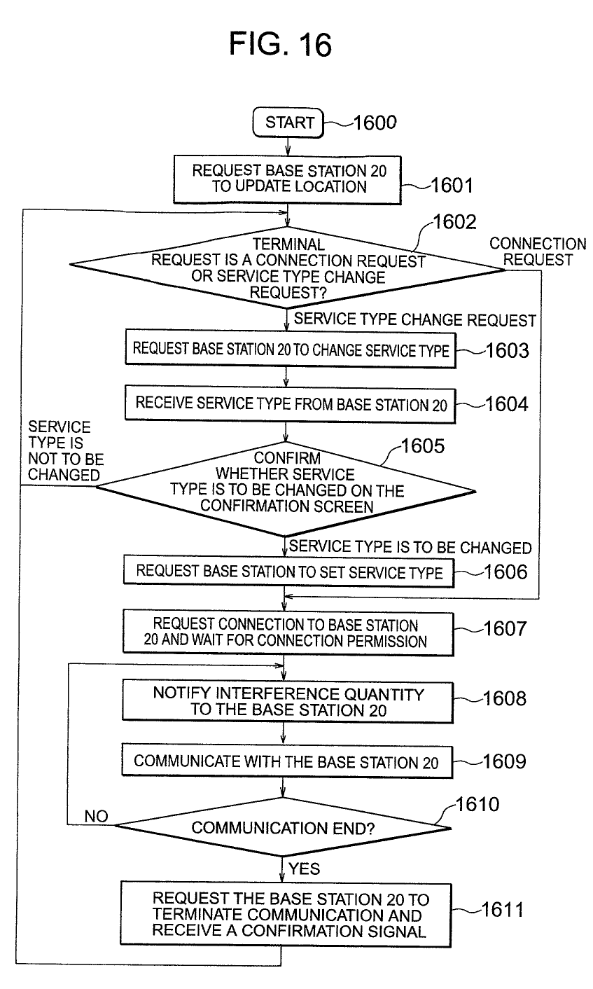

FIG. 16 is a flowchart of the processing of the terminal 10 in the present invention. Referring to FIG. 16, explanation will be given on the processing flowchart of the terminal 10 in the present invention. The processes of FIG. 16 are, for example, executed in the control block of the terminal 10. The control block is, for example, a CPU of the terminal 10. In a initial state, the flowchart is started (step 1600). According to step 500 shown in FIG. 14, the terminal 10 requests a location update to the base station 20 (step 1601). Here, the terminal 10 transmits not only the service type update request but also the device number 200 of the terminal 10.

When the terminal 10 is operated by the user of the terminal 10, the terminal 10 identifies the content requested to the terminal by the operation. The terminal 10 decides whether the request to the terminal 10 is a connection request or a service type change request (step 1602). The connection request in step 1602 corresponds to the case when the user of the terminal 10 selects the connection menu on the main menu display screen of the terminal 10 shown in FIGS. 15A-15D. The service type change request in step 1602 corresponds to the case when the user of the terminal 10 selects the service type change menu on the main menu display screen of the terminal 10 shown in FIGS. 15A-15D.

In step 1602, if the request to the terminal 10 is a service type change request, then according to step 1400 shown in FIG. 14, the terminal 10 requests the base station 20 to change the service type 205 (step 1603). The terminal 10 transmits the device number 200 to the base station 20 together with the request for changing the service type 200. On the other hand, in step 1602, if the request to the terminal 10 is a connection request, then the terminal 10 executes step 1607 as follows.

When the terminal 10 has requested the base station 20 to change the service type 205, the terminal 10 receives the service type 205 from the base station 20 (Step 1604) according to step 1405 shown in FIG. 14. When the terminal 10 has received the service type 205, the main menu display screen of FIG. 15A is changed to the display screen of FIG. 15B.

The terminal 10 decides whether the service type 205 has been changed by operation of the user of the terminal 10 (step 1605). The terminal 10 makes this decision according to whether the user of the terminal 10 has selected the menu for changing the service type 205. That is, in step 1605, if the menu for changing the service type 205 has been selected, then the terminal 10 decides that the service type 205 is to be changed. If the menu to return to the main menu has been selected, then the terminal 10 decides that the service type 205 is not to be changed.

In step 1605, if the service type 205 is decided to be changed, the terminal 10 requests the base station 20 to update the service type 205 (step 1606). The step 1606 corresponds to step 1406 shown in FIG. 14. In this case, in the terminal 10, the display screen of FIG. 15C is changed to the display screen of FIG. 15D. The terminal 10 transmits the device number 200 of the terminal 10 to the base station 20 together with the request for updating the service type 205. On the other hand, in step 1605, if the service type 205 is decided not to be changed, the terminal 10 waits for operation by the user of the terminal 10. When the terminal 10 is operated, the processing is started at step 1602. In this case, in the terminal 10, the display screen of FIG. 15C is changed back to the display screen of FIG. 15A.

After requesting the base station 20 to set the service type 205, the terminal 10 requests the base station to perform connection (step 1607) according to step 503 shown in FIG. 14. Here, the terminal 10 also transmits the device number 200 of the terminal 10 to the base station 20 together with the connection request. The terminal 10 is allowed to perform connection by the base station 20 according to step 508 shown in FIG. 14.

When the connection is allowed, the terminal 10 reports a radio wave interference quantity to the base station 20 (step 1608) according to step 509 shown in FIG. 14. The terminal 10 communicates with the base station 20 (step 1609). The terminal 10 repeats the process of steps 1608 and 1609 until the communication with the base station 20 is completed (step 1610). The terminal 10 decides that the communication is terminated (step 1610) when a communication end is specified by the user of the terminal 10. According to step 513 shown in FIG. 14, the terminal 10 requests the base station 20 to terminate the communication (step 1611). The terminal 10 receives a communication end confirmation signal according to step 516 shown in FIG. 14. Upon reception of the communication end confirmation signal, the terminal 10 enters a wait state for operation by the user of the terminal 10 and when operated, the terminal 10 starts processing at step 1602.

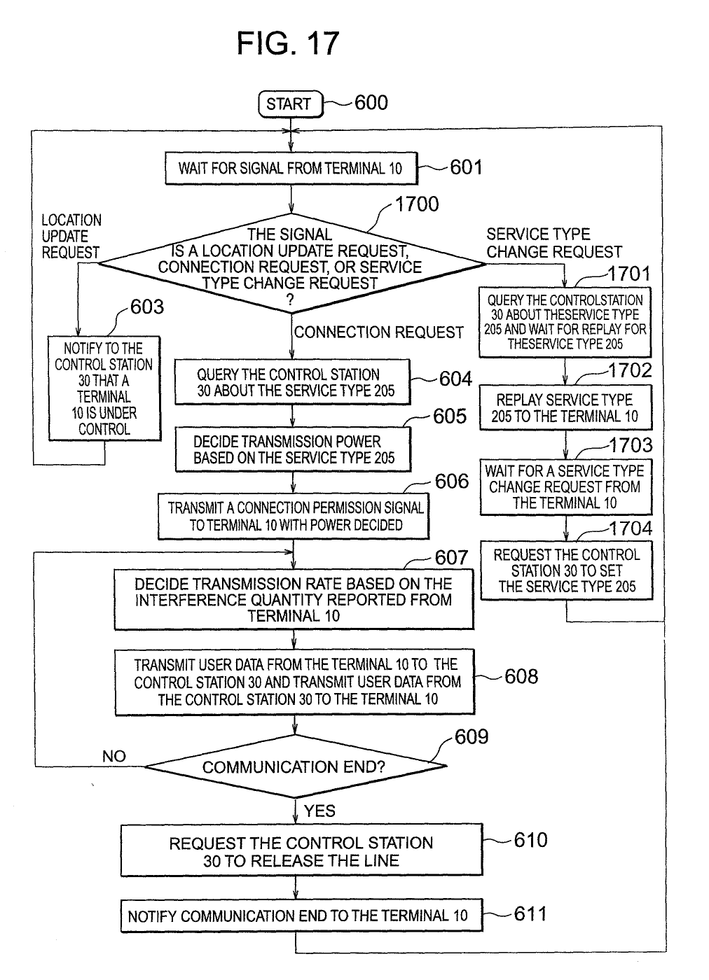

FIG. 17 is a processing flowchart of the base station 20 of the present invention. Referring to FIG. 17, explanation will be given on the processing flowchart of the base station 20 of the present invention. The flowchart of FIG. 17 is different from the flowchart of FIG. 7 in that step 602 is modified to step 1700 and steps 1701 to 1704 are added.

The base station 20, upon reception of a signal from the terminal 10, decides whether the signal is a location update request or a connection request or a service type change (update) request (step 1700). The service type update request in step 1700 corresponds to step 1400 in shown in FIG. 14.

In step 1700, if the signal is a service type change request, the base station 20 asks the control station 30 about the service type 205 according to step 1401 shown in FIG. 14 (step 1701). Here, the base station 20 receives the device number 200 of the terminal 10. The device number 200 received is transmitted to the control station 30 together with the query for service type 205. The base station 20 waits for replay about the service type 205 from the control station 30.

When the base station 20 receives a reply from the control station about the service type 205 according to step 1404 shown in FIG. 14, the base station 20 replies the service type 205 to the terminal 10 (step 1702). Step 1702 corresponds to step 1405 shown in FIG. 14.

The base station 20 waits for a request for set of the service type 205 from the terminal 10 (step 1703). When the base station 20 is requested to set the service type 205 from the terminal 10 according to step 1406 shown in FIG. 14, the base station requests the control station 30 to set the service type 205 (step 1704). Step 1704 corresponds to step 1407 shown in FIG. 14. Here, the base station 20 receives the device number 200 of the terminal 10. The device number 20 received is also transmitted to the control station 30 together with the service type setting request. When setting of the service type 205 is requested, the base station 20 returns to the wait state for a radio wave transmitted from the terminal 10 (step 601).

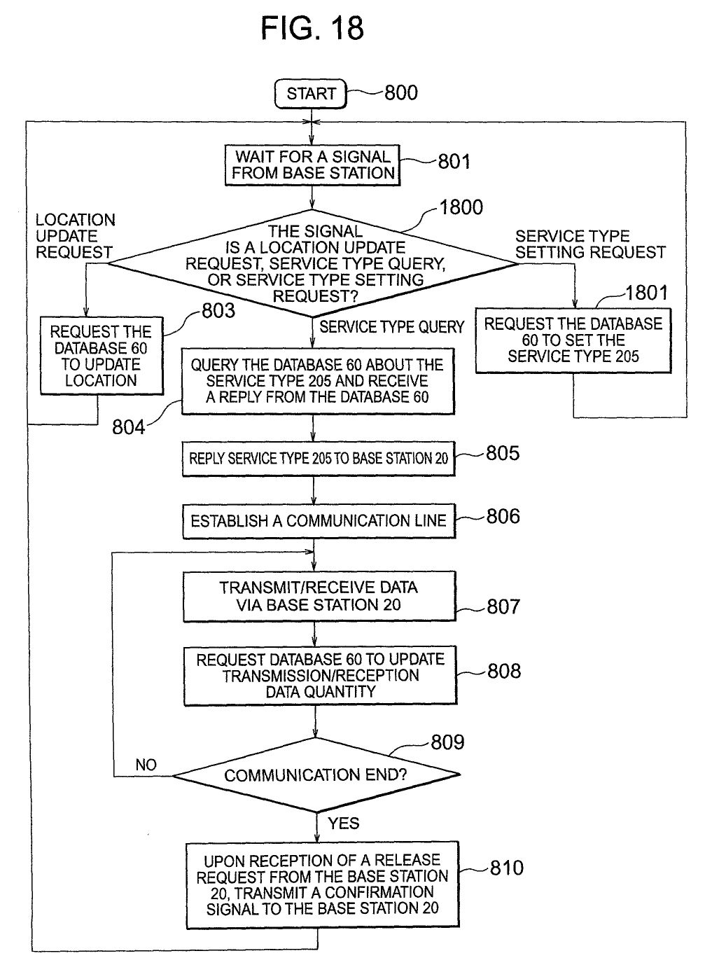

FIG. 18 is a processing flowchart of the control equipment 700 in the present invention. Referring to FIG. 18, explanation will be given on the processing flowchart of the control equipment 700 in the present invention. The flowchart of FIG. 18 is different from the flowchart of FIG. 9 in that the step 802 is modified to step 1800 and a step 1801 is added.

When the control equipment 30 has received a signal, the control station 30 decides whether the signal is a location update request, a service type query, or a service type setting request (step 1800). The service type setting request in step 1800 corresponds to step 1407 shown in FIG. 14.

In step 1800, if the signal is a service type setting request, the control station 30 requests the database 60 to update the service type 205 according to 1408 shown in FIG. 14 (step 803). Here, the control station 30 receives the device number 200 of the terminal 10. The device number 200 received is transmitted to the database 60 together with the service type setting request. When update of the service type 205 is requested, the control station 30 returns to the wait state for receiving a signal from the base station (step 801).

It should be noted that the process of steps 1401 to 1404 shown in FIG. 14 or steps 504 to 507 shown in FIG. 14 are executed according to the flowchart of step 804 and after, assuming that the signal is decided to be service type query in step 1800.

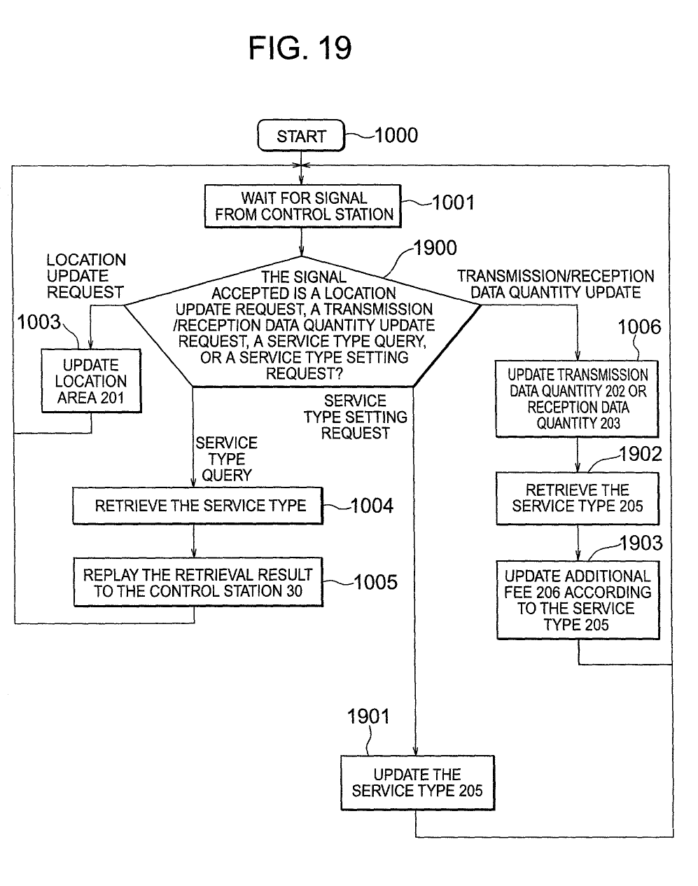

FIG. 19 is processing flowchart of the database control equipment 900 in the present invention. Referring to FIG. 19, explanation will be given on the processing flowchart of the database control equipment 900 of the present invention. The flowchart of FIG. 19 is different from the flowchart of FIG. 11 in that step 1002 is modified to step 1900, and steps 1901 to 1903 are added.

Upon reception of a signal, the database 60 decides whether the signal is a location update request, a request for updating the transmission data quantity 202 or the reception data quantity 203, a service type query, or a service type setting request (step 2900). The service type setting request in step 1900 corresponds to step 1408 shown in FIG. 14.

In step 1900, if the signal is decided to be a service type setting request, the database 60 updates the service type 205 shown in FIG. 3 (step 1901). The database 60 receives the device number 200 of the terminal 10 together with the service type setting request. According to the device number 200 of the terminal 10, the database 60 updates the service type 205 stored in the database equipment 901. For example, on the display screen of FIG. 15C, if the user of the terminal 10 selects a menu for changing the service type to “priority”, the database 60 updates the service type 205 to “priority”. When the database 60 has updated the service type 205, the database 60 enters the wait state for accepting a signal transmitted from the control station 30 (step 1001).

When the database 60 has updated the transmission data quantity 202 or the reception data quantity 203 stored in the database equipment 901, the database 60 retrieves the service type 205 stored in the database equipment 901 (step 1902). According to the retrieved service type, the database 60 calculates the additional charge shown in FIG. 3 and updates the charge (step 1903). For example, the database 60 updates the additional charge 206 stored in the database equipment 901 according to the additional charge caused by change of the service type 205. The additional charge may be calculated according to the time when the service type 205 is temporarily changed, or according to the reception data quantity 203 while the service type 205 is temporarily changed, or according to the number of times the service type 205 has been changed. When the additional charge 206 is updated, the database 60 returns to the wait state for accepting a signal from the control station 30 (step 1001).

It should be noted that the process of steps 1402 and 1403 shown in FIG. 14 or the process of steps 505 and 506 shown in FIG. 14 are executed according to the flowchart 1004 and after, assuming that the step 1002 has decided that the signal is a service type query.

According to the present invention, it is possible to further obtain effects as follows. The user of the terminal 10 may not want to perform communication under the contracted condition after contract has been made with the communication system provider. The user of the terminal 10 may want perform communication under a different condition each time the terminal 10 is used. In such a case, according to the present invention, by operating the terminal 10, it is possible to modify the condition after the contract has been made. Here, the condition modification includes, for example, communication quality change, transmission rate change, or communication fee change.

The present invention has been developed to control the interference between sectors or cells. The present invention can control communication quality for the respective users by using a smart antenna, an array antenna, or other technique for controlling the radio wave interference. When the smart antenna is applied to the present invention, the following expression used in this Specification is preferably replaced by an expression as follows. That is, the term “intensity of the transmission power of a down signal from the base station to the terminal” is preferably replaced by “density of power received by the terminal”. Accordingly, when the smart antenna is applied to the present invention, the base station decides the density of power received by the terminal according to the service type 205. That is, the beam is squeezed.

It should be further understood by those skilled in the art that the foregoing description has been made on embodiments of the invention and that various changes and modifications may be made in the invention without departing from the spirit of the invention and the scope of the appended claims.

We claims:

1. A radio communication apparatus comprising:
an antenna for transmitting and receiving a signal to/from a terminal;
a demodulator for demodulating the signal received by the antenna;
a terminal identification equipment for identifying information inherent to the terminal according to the signal demodulated; and
a priority control equipment for receiving a condition requested by a user of the terminal according to the information identified by the terminal identification equipment;
wherein the signal transmitted via the antenna to the terminal is based on condition received by the priority control equipment.

2. The radio communication apparatus according to claim 1, wherein said radio communication apparatus decides a density of power received by the terminal according to a communication state of the terminal reported from the terminal, allocates a signal to a time-divided packet slot, and transmits the signal to the terminal.

3. The radio communication apparatus according to claim 2, wherein
the antenna controls radio wave interference;
the condition is a condition related to the density of power received by the terminal; and
said radio communication apparatus further comprises a transmission power control equipment for controlling power transmitted from said radio communication apparatus.

4. The radio communication apparatus according to claim 3, further comprising:
a signal transmission rate decision equipment for changing a transmission rate of the signal transmitted to the terminal under said communication condition.

5. The radio communication apparatus according to claim 4, wherein
said information inherent to the terminal is a device number of the terminal; and
said condition is decided corresponding to the device number.

6. The radio communication apparatus according to claim 5, wherein
said communication state is related to the carrier-to-interference power ratio (C/I).

7. The radio communication apparatus according to claim 6, wherein said radio communication apparatus is a radio communication apparatus utilized for connection with a high-data-rate mobile telephone.

8. A radio communication apparatus comprising:
reception means for receiving a signal from a terminal;
demodulation means for demodulating the signal received by the reception means;
identification means for identifying information inherent to the terminal according to the demodulated signal;
condition fetch means for receiving a condition requested by a user of the terminal according to the information identified by the identification means; and
signal transmission means for transmitting a signal to the terminal according to the condition fetched by the condition fetch means.

9. The radio communication apparatus according to claim 8, wherein said radio communication apparatus decides intensity of power of a signal transmitted to the terminal and allocates the signal to a time-divided packet, thereby transmitting the signal to the terminal.

10. The radio communication apparatus according to claim 9, wherein
said condition is a condition related to power intensity of the signal transmitted to the terminal, and
said signal transmission means transmits the signal to the terminal with the intensity based on said condition.

11. The radio communication apparatus according to claim 10, further comprising signal transmission rate change means for changing the transmission rate of the signal transmitted to the terminal according to said communication state.

12. The radio communication apparatus according to claim 11, wherein
said information inherent to the terminal is a device number of the terminal; and
said condition is decided according to the device number.

13. The radio communication apparatus according to claim 12, wherein said communication state is related to C/I (carrier-to-interference power ratio).

14. The radio communication apparatus according to claim 13, wherein said radio communication apparatus is a radio communication apparatus used for connection with a high-data-rate mobile telephone.

15. A signal transmission/reception method applied to a radio communication apparatus, the method comprising steps of:
receiving a signal transmitted from a terminal;
identifying a content of the signal received;
in case the content is related to location of the terminal, notifying a location of the terminal to an upper-node station;
in case the content is related to connection from the terminal, querying the upper-node station about a condition requested by a user of the terminal; and
transmitting a signal to the terminal according to the said condition requested.

16. The signal transmission/reception method according to FIG. 15, further comprising steps of:
receiving report about communication state of the terminal from the terminal; and
deciding power intensity of a signal transmitted to the terminal, according to the communication state of the terminal.

17. The signal transmission/reception method according to claim 16, wherein said condition is a condition related to a power intensity of the signal transmitted to the terminal; and
the step of transmitting the signal further includes a step of:
using power of an intensity based on the condition, allocating the signal to a time-divided packet slot and transmitting the signal to the terminal.

18. The signal transmission/reception method according to claim 17, further comprising a step of: changing a transmission rate of the signal transmitted to the terminal, according to a communication state of the terminal.

19. The signal transmission/reception method, wherein the step of querying by which a reception of the condition queried is enabled includes the steps of:
receiving inherent information inherent to the terminal; and
transmitting the inherent information to an upper-node station.

20. The signal transmission/reception method according to claim 19, wherein
said inherent information is a device number of the terminal;
said condition is decided corresponding to the device number; and
said communication state is related to C/I (carrier-to-interference power ratio);
the method further comprising a step of:
in case said content is a request for change of said condition requested by the user of the terminal, requesting the upper-node station to set a changed condition requested by the user of the terminal.
